(19) United States
(12) Patent Application Publication
(10) Pub. No.: US 2026/0290252 A1
(43) Pub. Date: Sep. 24, 2026

(54) Gate Driver and Display Device Including the Same

(71) Applicant: LG Display Co., Ltd., Seoul (KR)

(72) Inventors: Min Jae Jeong, Paju-si (KR); Kyoung Lim Lee, Paju-si (KR); Ki Taeg Shin, Paju-si (KR)

(21) Appl. No.: 19/535,671

(22) Filed: Feb. 10, 2026

(30) Foreign Application Priority Data
Mar. 19, 2025 (KR) 10-2025-0035317

(51) Int. Cl. G09G 3/3266; G09G 3/3291

(52) U.S. Cl. CPC G09G 3/3266; G09G 3/3291; G09G 2300/0426; G09G 2330/021

(57) ABSTRACT

A gate driver according to one or more embodiments and a display device including the same are disclosed. The gate driver includes a plurality of signal transfer stages that are connected in a cascade via a carry line to which a carry signal is applied from a previous signal transfer stage and output a gate signal according to a clock signal. An n^{th} (n is a natural number) signal transfer stage includes a control circuit configured to receive an (n-1)^{th} carry signal from a previous signal transfer stage, an (n+1)^{th} carry signal from a next signal transfer stage, and a clock signal, and charges or discharges a first control node and a second control node. The n^{th} signal transfer stage further includes an output circuit that outputs a gate signal based on potentials of the first control node and the (n+1)^{th} carry signal.

### CROSS-REFERENCE TO RELATED APPLICATION

The present application claims priority to Republic of Korea Patent Application No. 10-2025-0035317, filed on Mar. 19, 2025, which is incorporated herein by reference in its entirety.

### BACKGROUND

### Field

The present disclosure relates to a gate driver and a display device including the same.

### Discussion of Related Art

Electroluminescent display devices are divided into inorganic light emitting display devices and organic light emitting display devices according to a material of a light emitting layer. An active-matrix type organic light emitting display device includes an organic light emitting diode (hereinafter referred to as an “OLED”) which emits light by itself, and has advantages in that a response speed is fast and luminous efficiency, luminance, and a viewing angle are large.

In organic light-emitting display devices, organic light-emitting diodes (referred to as "OLEDs") are formed in each of pixels. These organic light display devices not only respond quickly and have excellent light-emitting efficiency, luminance, and viewing angle, but also have excellent contrast ratio and color reproduction rate because they can express black tones as complete black.

Some of display devices, for example, a liquid crystal display device or an organic light emitting display device includes a display panel including a plurality of sub-pixels, a driver outputting a driving signal for driving the display panel, a power supply generating power to be supplied to the display panel or the driver, and the like. The driver includes a gate driver that supplies a scan signal or a gate signal to the display panel, and a data driver that supplies a data signal to the display panel.

### SUMMARY

In embodiments of the present disclosure, the gate driver has a structure that utilizes a clock signal application method or a DC voltage application method. The clock signal application method has excellent output characteristics by applying a clock signal, but since the clock signal is applied alternately as high voltage and low voltage through a pull-up transistor to generate the output signal, power consumption increases due to the parasitic capacitance formed between the gate electrode and drain electrode of the pull-up transistor.

The DC voltage application method generates the output signal by applying a DC voltage and using the on/off of a pull-up transistor and a pull-down transistor, so power consumption is reduced compared to the clock signal application method, but the falling time of the output signal becomes longer.

The present disclosure is directed to solving all the above-described necessity and problems.

The present disclosure provides a gate driver and a display device including the same.

It should be noted that objects of the present disclosure are not limited to the above-described objects, and other objects of the present disclosure will be apparent to those skilled in the art from the following descriptions.

A gate driver according to embodiments of the present disclosure may include a plurality of signal transfer stages that are connected in a cascade via a carry line to which a carry signal is applied from a previous signal transfer stage and output a gate signal according to a clock signal, wherein an n^{th} (n is a natural number) signal transfer stage comprises a control circuit configured to receive an (n-1)^{th} carry signal from a previous signal transfer stage, an (n+1)^{th} carry signal from a next signal transfer stage, and a clock signal and charges or discharges a first control node and a second control node; and an output circuit that outputs a gate signal based on potentials of the first control node and the (n+1)^{t}h carry signal.

A display device according to embodiments of the present disclosure may include a display panel on which a plurality of data lines, a plurality of gate lines intersecting the data lines, a plurality of power lines to which different constant voltages are applied, and a plurality of sub-pixels are arranged; a data driver configured to supply a data voltage of pixel data to the data lines; and a gate driver configured to supply a gate signal to the gate lines, wherein the gate driver comprises a plurality of signal transfer stages that are connected in a cascade via a carry line to which a carry signal is applied from a previous signal transfer stage and output a gate signal according to a clock signal, wherein an n^{th} (n is a natural number) signal transfer stage includes a control circuit configured to receive an (n-1)^{th} carry signal from a previous signal transfer stage, an (n+1)^{th} carry signal from a next signal transfer stage, and a clock signal and charges or discharges a first control node and a second control node; and an output circuit that outputs a gate signal based on potentials of the first control node and the (n+1)^{th} carry signal.

In the present disclosure, the pull-up transistor outputting the gate signal is turned on by a first control node and the pull-down transistor is turned on by a carry signal, so that it is possible to reduce the bias stress of the pull-down transistor and also reduce the falling time of the gate signal.

The present disclosure may reduce power consumption because the gate signal is generated using a DC voltage other than a clock signal.

The present disclosure may enable low-power driving because power consumption may be reduced.

The effects of the present disclosure are not limited to the above-mentioned effects, and other effects that are not mentioned will be apparently understood by those skilled in the art from the following description and the appended claims.

### BRIEF DESCRIPTION OF THE DRAWINGS

The above and other objects, features, and advantages of the present disclosure will become more apparent to those of ordinary skill in the art by describing embodiments thereof in detail with reference to the attached drawings, in which:

FIG. 1 is a block diagram illustrating a display device according to one or more embodiments of the present disclosure.

FIG. 2 is a schematic diagram illustrating a gate driver according to one or more embodiments of the present disclosure.

FIGS. 3 and 4 are diagrams for describing basic operations of the gate driver.

FIGS. 5 and 6 are diagrams illustrating a gate driver according to a first embodiment of the present disclosure.

FIG. 7 is a circuit diagram illustrating details of the gate driver shown in FIG. 5.

FIG. 8 is a waveform diagram illustrating voltages of the input/output signals and control nodes of the gate driver shown in FIG. 7.

FIGS. 9 - 14 are diagrams for explaining the operating principle of the gate driver.

FIGS. 15 and 16 are diagrams illustrating a gate driver according to a second embodiment of the present disclosure.

FIGS. 17 and 18 are diagrams illustrating simulation results of the gate driver according to one or more embodiments of the present disclosure.

### DETAILED DESCRIPTION

Advantages and features of the present disclosure and methods of achieving them will become apparent with reference to preferable embodiments, which are described in detail, in conjunction with the accompanying drawings. However, the present disclosure is not limited to the embodiments to be described below and may be implemented in different forms, the embodiments are only provided to completely disclose the present disclosure and completely convey the scope of the present disclosure to those skilled in the art, and the present disclosure is defined by the disclosed claims.

Since the shapes, sizes, proportions, angles, numbers, and the like disclosed in the drawings for describing the embodiments of the present disclosure are only exemplary, the present disclosure is not limited to the illustrated items. The same reference numerals indicate the same components throughout the disclosure. Further, in describing the present disclosure, when it is determined that a detailed description of related known technology may unnecessarily obscure the gist of the present disclosure, the detailed description thereof will be omitted.

When ‘including,’ ‘having,’ ‘comprising,’ and the like mentioned in the present disclosure are used, other parts may be added unless ‘only’ is used. A case in which a component is expressed in a singular form includes a plural form unless explicitly stated otherwise.

In interpreting the components, it should be understood that an error range is included even when there is no separate explicit description.

In the case of a description of a positional relationship, for example, when the positional relationship of two parts is described as ‘on,’ ‘at an upper portion,’ ‘at a lower portion,’ ‘next to, and the like, one or more other parts may be located between the two parts unless ‘immediately’ or ‘directly’ is used.

Although first, second, and the like are used to describe various components, these components are not limited by these terms. These terms are only used to distinguish one component from another. Accordingly, a first component, which is mentioned, below may also be a second component within the technical spirit of the present disclosure.

The same reference numerals may refer to substantially the same elements throughout the present disclosure.

The following embodiments can be partially or entirely bonded to or combined with each other and can be linked and operated in technically various ways. The embodiments can be carried out independently of or in association with each other.

Hereinafter, various embodiments of the present disclosure will be described in detail with reference to the accompanying drawings.

In a display device of the present disclosure, the pixel circuit and the gate driving circuit may include a plurality of transistors. Transistors may be implemented as oxide thin film transistors (oxide TFTs) including an oxide semiconductor, low temperature polysilicon (LTPS) TFTs including low temperature polysilicon, or the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor (p-channel metal-oxide semiconductor (PMOS), since carriers are holes, a source voltage is higher than a drain voltage such that holes may flow from a source to a drain. In the p-channel transistor, since holes flow from the source to the drain, a current flows from the source to the drain. It should be noted that a source and a drain of a transistor are not fixed. For example, a source and a drain may be changed according to an applied voltage. Therefore, the disclosure is not limited due to a source and a drain of a transistor. In the following description, a source and a drain of a transistor will be referred to as a first electrode and a second electrode.

A gate signal swings between a gate-on voltage and a gate-off voltage. The gate-on voltage is set to a voltage higher than a threshold voltage of a transistor, and the gate-off voltage is set to a voltage lower than the threshold voltage of the transistor.

The transistor is turned on in response to the gate-on voltage and is turned off in response to the gate-off voltage. In the case of the n-channel transistor, a gate-on voltage may be a gate high voltage, and a gate-off voltage may be a gate low voltage. In the case of the p-channel transistor, a gate-on voltage may be a gate low voltage, and a gate-off voltage may be a gate high voltage.

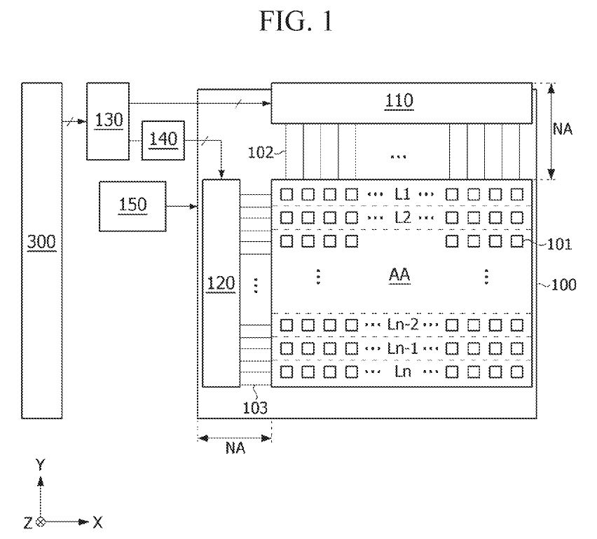

FIG. 1 is a block diagram illustrating a display device according to one or more embodiments of the present disclosure.

Referring to FIG. 1, the display device according to one or more embodiments of the present disclosure includes a display panel 100, and a display panel driving circuit for writing pixel data to pixels of the display panel 100. Additionally, the display device includes a power supply 150.

The display panel 100 may be, but not limited to, a panel having a rectangular structure with a length in the X-axis direction, a width in the Y-axis direction, and a thickness in the Z-axis direction. For example, the display panel 100 may be a heterogeneous panel of which at least a portion is curved or elliptical.

The display area AA of the display panel 100 includes a pixel array to display an input image. The pixel array includes a plurality of data lines 102, a plurality of gate lines 103 crossing the data lines 102, and pixels arranged in a matrix form. The display panel 100 may further include power lines commonly connected to the pixels. The power lines may be commonly connected to pixel circuits to supply a voltage required for driving pixels 101 to the pixels 101.

Each of the pixels 101 may be divided into a red sub-pixel, a green sub-pixel, and a blue sub-pixel for color implementation. Each pixel may further include a white sub-pixel. Each sub-pixel includes a pixel circuit for driving a light emitting element. The light emitting element may include an OLED or an inorganic light emitting diode (LED). Each pixel circuit is connected to the data lines, the gate lines, and the power lines. In the following description, a pixel may be interpreted as a sub-pixel.

The display area AA includes a plurality of pixel lines L1 to Ln. Each of the pixel lines L1 to Ln includes one line of pixels arranged along the line direction (X-axis direction) in the pixel array of the display panel 100. Those pixels arranged in one pixel line share the gate lines 103. The sub-pixels arranged in the column direction Y along the data line direction share the same data line 102. One horizontal period is a time obtained by dividing one frame period by the total number of pixel lines L1 to Ln.

The display panel 100 may be implemented with a non-transmissive display panel or a transmissive display panel. The transmissive display panel may be applied to a transparent display device in which an image is displayed on the screen and a real object in the background is visible. The display panel 100 may be made of a flexible display panel.

The power supply 150 receives an input voltage applied from the host system 300 and outputs a voltage needed to drive the pixels 101 of the display panel 100 and the display panel driving circuit. To this end, the power supply 150 may include a direct current to direct current converter (DC-DC converter). The DC-DC converter may include a charge pump, a regulator, a buck converter, a boost converter, and the like. The power supply 150 may output a constant voltage (or direct current voltage), such as gate-on voltage, gate-off voltage, pixel driving voltage, cathode voltage, reference voltage, IC driving voltage of the display panel driving circuit, through the DC-DC converter. The gate-on voltage and the gate-off voltage may be supplied to the level shifter 140 and the gate driver 120. Voltages such as pixel driving voltage, cathode voltage, and reference voltage may be supplied to the pixels 101 through the power lines commonly connected to the pixels 101.

The power supply 150 may further include a gamma voltage generator. The gamma voltage generator receives a high-potential reference voltage and a low-potential reference voltage and outputs a plurality of gamma reference voltages divided at specific intervals on a preset gamma curve, for example, a 2.2 gamma curve. The gamma reference voltages are supplied to the data driver 110. In the data driver 110, the gamma reference voltages are subdivided by a voltage dividing circuit into grayscale voltages. The gamma voltage generator may be implemented with a programmable gamma circuit that may adjust the voltage of each of the gamma reference voltages according to digital data. The timing controller 130, the host system 300, or a separate external device may update digital data stored in a register of the programmable gamma circuit through a communication interface.

The display panel driving circuit writes pixel data of the input image to the pixels 101 of the display panel 100 under the control of the timing controller 130. The display panel driving circuit includes a data driver 110 and a gate driver 120.

The display panel driving circuit may further include de-multiplexers (DEMUX) provided between the data driver 110 and the data lines 102, but embodiments of the present disclosure are not limited thereto. When the de-multiplexers are provided between output terminals of the data driver 110 and the data lines 102, the number of channels (or the number of output terminals) of the data driver 110 to be electrically connected to the data lines 102 may be reduced.

The display panel driving circuit may further include a touch sensor driver for driving touch sensors. The touch sensor driver is not shown in FIG. 1. The data driver 110 and the touch sensor driver may be integrated into one source drive IC.

The data driver 110 receives pixel data of the input image as a digital signal from the timing controller 130 and outputs a data voltage. The data driver 110 may receive gamma reference voltages and generate gamma compensation voltages for each grayscale through a voltage dividing circuit. The per-grayscale gamma compensation voltages are supplied to a digital to analog converter (hereinafter referred to as “DAC”) disposed in each channel of the data driver 110.

The data driver 110 samples and latches digital data received from the timing controller 130 and then inputs the digital data to the DAC. Here, the digital data includes pixel data of the input image. The DAC converts the pixel data into a gamma compensation voltage and outputs a data voltage of the pixel data.

The gate driver 120 may be formed on the display panel 100 together with the circuit elements and wiring lines of the display area AA. The gate driver 120 may be disposed in at least one of left and right non-display areas NA outside the display area AA in the display panel 100 or at least a part thereof may be disposed within the display area AA.

The gate driver 120 sequentially outputs pulses of gate signals to the gate lines 103 under the control of the timing controller 130. The gate driver 120 may sequentially supply the gate signals to the gate lines 103 by shifting the pulses of the gate signals using a shift register. In one or more embodiments where a plurality of gate signals is applied to each of the pixels, the gate driver 120 may include a plurality of shift registers. The gate signals may include scan signals and light emission signals (or EM signals) input to the pixel circuit through a plurality of gate lines.

The circuitry of the gate driver 120 according to one or more embodiments may be implemented with a pull-up transistor that is turned on in response to a first control node (Q node) and a pull-down transistor that is turned on in response to a carry signal transferred from the previous signal transfer stage other than a second control node (QB node). The falling time of the gate signal may be reduced because the pull-down transistor is turned on in response to the carry signal transmitted from the previous signal transfer stage.

The timing controller 130 receives digital video data of an input image and a timing signal synchronized with this data from the host system 300. The timing signal may include a vertical synchronization signal Vsync, a horizontal synchronization signal Hsync, and a data enable signal DE. Since the vertical period and horizontal period may be known by counting the data enable signal DE, the vertical synchronization signal Vsync and the horizontal synchronization signal Hsync may be omitted. The horizontal synchronization signal Hsync and the data enable signal DE have a periodicity of 1 horizontal period (1H).

The timing controller 130 may control the display panel driving circuit by generating a data timing control signal for controlling the operation timing of the data driver 110 and a gate timing control signal for controlling the operation timing of the gate driver 120 based on the timing signals Vsync, Hsync, DE received from the host system 300. The timing controller 130 may synchronize the data driver 110 and the gate driver 120 by controlling the operation timing of the display panel driving circuit.

The gate timing control signal output from the timing controller 130 may be input to the shift register of the gate driver 120 through the level shifter 140. The level shifter 140 may convert a voltage of the gate timing control signal received from the timing controller 130 to a swing width between the gate-on voltage and the gate-off voltage and supply it to the gate driver 120.

The host system 300 may include a main board of one of a television system, a set-top box, a navigation system, a personal computer (PC), a vehicle system, a mobile terminal, and a wearable terminal. The host system 300 may scale an image signal from a video source according to the resolution of the display panel 100, and may transmit it to the timing controller 130 together with the timing signals.

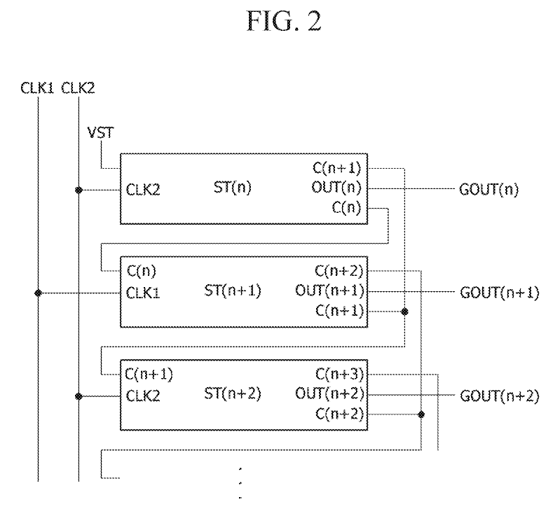

FIG. 2 is a schematic diagram illustrating a gate driver according to one or more embodiments of the present disclosure.

Referring to FIG. 2, the gate driver 120 according to one or more embodiments of the present disclosure may include a plurality of signal transfer stages ST(n), ST(n+1), ST(n+2), ... that are connected in a cascade manner via a carry line through which a carry signal is transmitted.

Each of the signal transfer stages ST(n), ST(n+1), ST(n+2), ... receives a start pulse or a carry signal output from the previous signal transfer stage, a carry signal output from the next signal transfer stage, and a clock signal CLK1 or CLK2. The clock signal CLK1 may be an antiphase phase signal obtained by inverting the phase of the clock signal CLK2. Although a case where a two-phase clock signal is used is described here as an example, two or more phase clock signals may be used.

For example, the first signal transfer stage ST(1) starts to be driven according to a start pulse VST and a carry signal output from the next signal transfer stage, and the other signal transfer stages ST(2), ST(3), ... start to be driven by receiving a carry signal output from the previous signal transfer stage and a carry signal output from the next signal transfer stage.

These signal transfer stages ST(n), ST(n+1), ST(n+2), ... may sequentially output gate signals GOUT(n), GOUT(n+1), GOUT(n+2), ... by shifting a start pulse VST or a carry signal output from the previous signal transfer stage and a carry signal output from the next signal transfer stage in accordance with the timing of the clock signal CLK1 or CLK2.

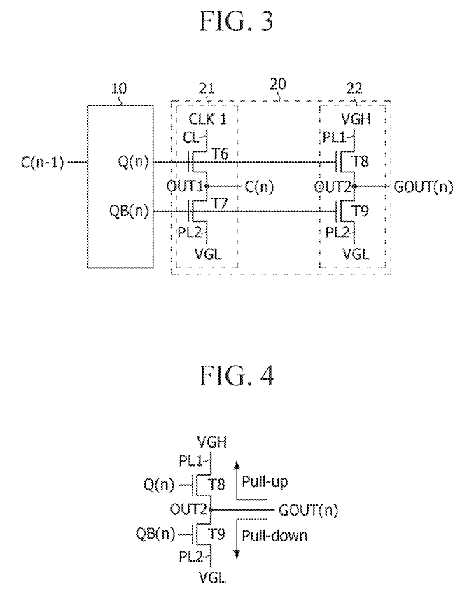

FIGS. 3 and 4 are diagrams for describing basic operations of the gate driver.

Referring to FIGS. 3 and 4, each signal transfer stage of the basic gate driver includes a control circuit 10 and an output circuit 20. The control circuit 10 may charge or discharge a first control node (hereinafter, referred to as "Q node") and a second control node (hereinafter, referred to as "QB node").

The control circuit 10 may include a charge/discharge circuit that controls charging/discharging of the Q node Q(n) and the QB node QB(n), and an inverter circuit that inverts the voltage of the Q node Q(n) and applies it to the QB node QB(n).

The output circuit 20 may output a carry signal C(n) and a gate signal GOUT(n) in correspondence to the potentials of the Q node Q(n) and the QB node QB(n). The output circuit 20 may include a first output circuit 21 that outputs a carry signal C(n) and a second output circuit 22 that outputs a gate signal GOUT(n).

The gate signal described here may be, but not limited to, a scan signal.

The first output circuit 21 may include first buffer transistors that output a carry signal C(n). The first buffer transistors may include a sixth transistor T6, which is a pull-up transistor that turns on based on the potential of the Q node Q(n), and a seventh transistor T7, which is a pull-down transistor that turns on based on the potential of the QB node QB(n). The sixth transistor T6 includes a gate electrode connected to the Q node Q(n), a first electrode connected to the clock signal line CL, and a second electrode connected to a first output node OUT1. The seventh transistor T7 includes a gate electrode connected to the QB node QB(n), a first electrode connected to the first output node OUT1, and a second electrode connected to a second power line PL2 to which a low-potential voltage VGL is applied.

The second output circuit 22 may include second buffer transistors that output a gate signal GOUT(n). The second buffer transistors may include an eighth transistor T8, which is a pull-up transistor that turns on based on the potential of the Q node Q(n), and a ninth transistor T9, which is a pull-down transistor that turns on based on the potential of the QB node QB(n). The eighth transistor T8 includes a gate electrode connected to the Q node Q(n), a first electrode connected to a first power line PL1 to which a high-potential voltage VGH is applied, and a second electrode connected to a second output node OUT2. The ninth transistor T9 includes a gate electrode connected to the QB node QB(n), a first electrode connected to the second output node OUT2, and a second electrode connected to a second power line PL2.

As illustrated in FIG. 4, the second buffer transistors T8 and T9 may pull up or pull down the voltage of the gate signal GOUT(n) based on the high-potential voltage VGH and the low-potential voltage VGL. In this case, since the time when the ninth transistor T9 is turned on takes up most of the time compared to the time when the eighth transistor T8 is turned on, the bias stress of the ninth transistor T9, i.e., the positive bias temperature stress (PBTS), may increase.

In addition, the potential of the QB node QB(n) for turning on the ninth transistor T9 rises slowly due to the driving scheme of the inverter circuit, resulting in a longer falling time. The driving scheme of the inverter circuit will be described in detail below.

To address this, the embodiment proposes a structure capable of reducing the falling time of the ninth transistor. The ninth transistor according to the embodiment is intended to be implemented in a structure that may be operated by a carry signal rather than by the voltage of the second control node.

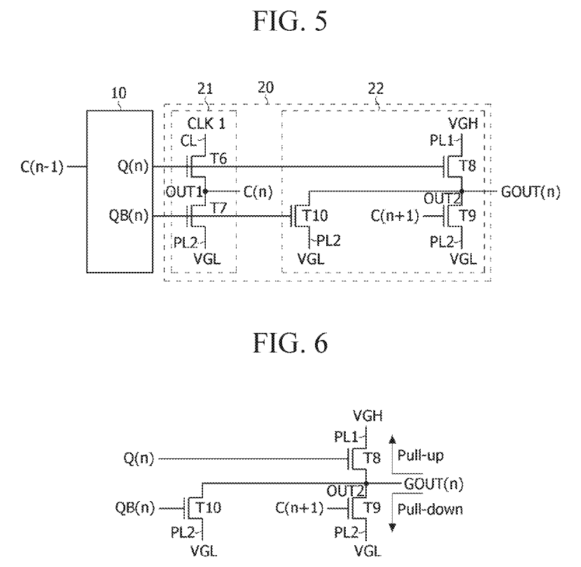

FIGS. 5 and 6 are diagrams illustrating a gate driver according to a first embodiment of the present disclosure.

Referring to FIGS. 5 and 6, each signal transfer stage of the gate driver according to the first embodiment of the present disclosure includes a control circuit 10 and an output circuit 20. The control circuit 10 may charge or discharge the Q node Q(n) and the QB node QB(n).

The control circuit 10 may include a charge/discharge circuit that controls charging and discharging of the Q node Q(n) and the QB node QB(n), and an inverter circuit that inverts the voltage of the Q node Q(n) and applies it to the QB node QB(n).

The output circuit 20 may output a carry signal C(n) and a gate signal GOUT(n) in correspondence to the potential of the Q node Q(n) and the QB node QB(n). The output circuit 20 may include a first output circuit 21 that outputs a carry signal C(n), and a second output circuit 22 that outputs a gate signal GOUT(n).

The first output circuit 21 may include first buffer transistors that output a carry signal C(n). The first buffer transistors may include a sixth transistor T6, which is a pull-up transistor that is turned on based on the potential of the Q node Q(n), and a seventh transistor T7, which is a pull-down transistor that is turned on based on the potential of the QB node QB(n).

The sixth transistor T6 includes a gate electrode connected to the Q node Q(n), a first electrode connected to the clock signal line CL to which the clock signal is applied, and a second electrode connected to a first output node OUT1. The seventh transistor T7 includes a gate electrode connected to the QB node QB(n), a first electrode connected to the first output node OUT1, and a second electrode connected to a second power line PL2.

The second output circuit 22 may include second buffer transistors that output a gate signal GOUT(n). The second buffer transistors may include an eighth transistor T8, which is a pull-up transistor that is turned on based on the potential of the Q node Q(n), and a ninth transistor T9, which is a pull-down transistor that is turned on based on the potential of a carry signal C(n+1) applied from the next signal transfer stage.

The eighth transistor T8 includes a gate electrode connected to the Q node Q(n), a first electrode connected to the first power line PL1, and a second electrode connected to the second output node OUT2. The ninth transistor T9 includes a gate electrode to which a carry signal C(n+1) is applied from the next signal transfer stage, a first electrode connected to the second output node OUT2, and a second electrode connected to the second power line PL2.

The second output circuit 22 may include a tenth transistor T10, which is an auxiliary transistor that is turned on based on the potential of the QB node QB(n) and maintains the voltage of the output node at a low potential voltage.

The tenth transistor T10 includes a gate electrode connected to the QB node QB(n), a first electrode connected to the second output node OUT2, and a second electrode connected to the second power line PL2.

As shown in FIG. 6, the ninth transistor T9 is turned on by the carry signal C(n+1) of the next signal transfer stage, and thus may only be turned on at the high-level voltage of the carry signal C(n+1). For example, the ninth transistor T9 may be turned on for one horizontal period (1H) during which the high-level voltage of the carry signal C(n+1) is applied, without being limited thereto.

Compared to the time it takes for the ninth transistor T9 to be turned on and pull down the gate signal voltage while the QB node QB(n) is being charged, the time it takes for the ninth transistor T9 to be turned on and pull down the gate signal voltage due to the high-level voltage of the carry signal C(n+1) transferred from the next signal transfer stage is shorter. Thereby, the falling time of the gate signal may be reduced.

Since the low-level voltage of the gate signal occupies most of the output time, the voltage of the gate line connected to the second output node OUT2 should be discharged to a low-potential voltage and maintained at the low-potential voltage.

However, if the second output circuit 22 is composed only of the eighth transistor T8 and the ninth transistor T9, a ripple may occur at the second output node OUT2 when the ninth transistor T9 is turned off. That is, since the ninth transistor T9 is turned on for a short time such as 1H by a carry signal C(n+1) transferred from the next signal transfer stage and turned off for the remaining time, the second output node OUT2 is in a floating state during the time T9 is turned off, so a ripple may occur at the second output node OUT2 due to external static electricity in addition to clock signal application, data voltage application, and touch operation.

To address this, a tenth transistor T10 connected in parallel with the ninth transistor T9 is further provided between the second output node OUT2 and the second power line. The tenth transistor T10 may be turned on when the voltage of the QB node QB(n) is a high-level voltage to maintain the voltage of the second output node OUT2 at the low-potential voltage VGL.

That is, since the ninth transistor T9 is fully turned on by the high-level voltage of the carry signal, the falling time of the gate signal output through the second output node OUT2 may be reduced. Here, since the voltage of the QB node QB(n) remains at a high level for most of the time, the tenth transistor T10 may be turned on.

Hence, the bias stress of the ninth transistor T9 may be reduced. Additionally, the tenth transistor T10 serves to prevent ripples occurring at the second output node OUT2. This may allow the channel width of the tenth transistor T10 to be designed smaller. For example, the channel width of the tenth transistor T10 may be designed smaller than that of the ninth transistor T9.

In this way, as the channel width decreases, the size of the transistor decreases, which is advantageous for securing space and reducing costs.

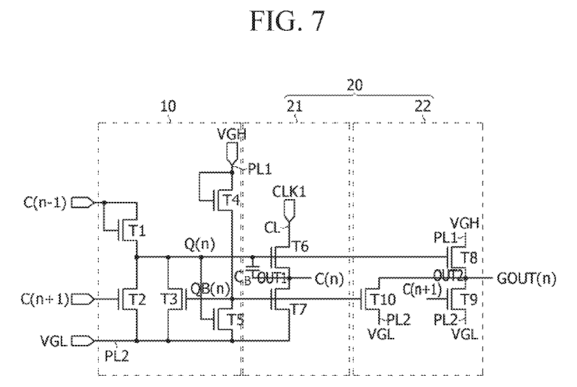

FIG. 7 is a circuit diagram illustrating details of the gate driver shown in FIG. 5. The case where the transistors constituting the gate driver are implemented with n-channel TFTs is described here as an example, without being limited thereto. The gate driver illustrated in FIG. 7 represents the circuit of the n^{th} (n is a natural number) signal transfer stage ST(n) illustrated in FIG. 5. Other signal transfer stages may also be implemented with a circuit substantially identical to the n^{th} signal transfer stage ST(n).

Referring to FIG. 7, the gate driver according to one or more embodiments of the present disclosure may include a first control node (hereinafter, referred to as "Q node"), a second control node (hereinafter, referred to as "QB node"), a control circuit 10, and an output circuit 20.

The control circuit 10 may serve to charge and discharge the Q node Q(n) and the QB node QB(n). The control circuit 10 may include a first transistor T1, a second transistor T2, a third transistor T3, a fourth transistor T4, and a fifth transistor T5.

The first transistor T1 is turned on by the carry signal C(n-1) of the previous signal transfer stage and applies the carry signal to the Q node Q(n), thereby charging the Q node Q(n) with the high-level voltage of the carry signal C(n-1). The first transistor T1 includes a gate electrode and first electrode to which the carry signal C(n-1) of the previous signal transfer stage is applied, and a second electrode connected to the Q node Q(n).

The second transistor T2 is turned on by the carry signal C(n+1) of the next signal transfer stage and connects the second power line PL2 to which the low-potential voltage VGL is applied to the Q node Q(n), thereby discharging the voltage of the Q node Q(n) to the low-potential voltage VGL. The second transistor T2 includes a gate electrode to which the carry signal C(n+1) of the next signal transfer stage is applied, a first electrode connected to the Q node Q(n), and a second electrode connected to the second power line PL2.

The third transistor T3 is turned on by the voltage of the QB node QB(n) and connects the second power line PL2 to the Q node Q(n), thereby discharging the voltage of the Q node Q(n) to the low-potential voltage VGL. The third transistor T3 includes a gate electrode connected to the QB node QB(n), a first electrode connected to the Q node Q(n), and a second electrode connected to the second power line PL2.

The fourth transistor T4 is turned on by the high-potential voltage VGH and connects the first power line PL1 to which the high-potential voltage VGH is applied to the QB node QB(n), thereby charging the QB node QB(n) with the high-potential voltage VGH. The fourth transistor T4 includes a gate electrode and first electrode connected to the first power line PL1, and a second electrode connected to the QB node QB(n).

The fifth transistor T5 is turned on by the voltage of the Q node Q(n) and connects the second power line PL2 to the QB node QB(n), thereby discharging the QB node QB(n) to the low-potential voltage VGL. The fifth transistor T5 includes a gate electrode connected to the Q node Q(n), a first electrode connected to the QB node QB(n), and a second electrode connected to the second power line PL2.

The output circuit 20 may include a first output circuit 21 that outputs a carry signal, and a second output circuit 22 that outputs a gate signal.

The first output circuit 21 may include a sixth transistor T6, a seventh transistor T7, and a capacitor CB.

The sixth transistor T6 is turned on by the voltage of the Q node Q(n) and connects the clock signal line CL to which the clock signal CLK1 is applied to the first output node OUT1, thereby applying the clock signal CLK1 to the first output node OUT1. The sixth transistor T6 includes a gate electrode connected to the Q node Q(n), a first electrode connected to the clock signal line CL, and a second electrode connected to the first output node OUT1.

The seventh transistor T7 is turned on by the voltage of the QB node QB(n) and connects the second power line PL2 to the first output node OUT1, thereby applying the low-potential voltage VGL to the first output node OUT1. The seventh transistor T7 includes a gate electrode connected to the QB node QB(n), a first electrode connected to the first output node OUT1, and a second electrode connected to the second power line PL2.

The capacitor CB may be connected between the gate electrode and the second electrode of the sixth transistor T6 to boost the voltage of the Q node Q(n) connected to the gate electrode of the sixth transistor T6.

The case where the capacitor CB is connected between the gate electrode and the second electrode of the sixth transistor T6 is described here as an example, without being limited thereto. For example, the capacitor CB may be connected between the gate electrode and the second electrode of the eighth transistor T8.

The second output circuit 22 may include an eighth transistor T8, a ninth transistor T9, and a tenth transistor T10.

The eighth transistor T8 is turned on by the voltage of the Q node Q(n) and connects the first power line PL1 to the second output node OUT2, thereby applying the high-potential voltage VGH to the second output node OUT2. The eighth transistor T8 includes a gate electrode connected to the Q node Q(n), a first electrode connected to the first power line PL1, and a second electrode connected to the second output node OUT2.

The ninth transistor T9 is turned on by the carry signal C(n+1) supplied from the next signal transfer stage and connects the second power line PL2 to the second output node OUT2, thereby applying the low-potential voltage VGL to the second output node OUT2. The ninth transistor T9 includes a gate electrode to which the carry signal C(n+1) is applied, a first electrode connected to the second output node OUT2, and a second electrode connected to the second power line PL2.

The tenth transistor T10 is turned on by the voltage of the QB node QB(n) and connects the second power line PL2 to the second output node OUT2, thereby applying the low-potential voltage VGL to the second output node OUT2. The tenth transistor T10 includes a gate electrode connected to the QB node QB(n), a first electrode connected to the second output node OUT2, and a second electrode connected to the second power line PL2.

In the embodiment, the eighth transistor T8 is used as a pull-up transistor, the ninth transistor T9 is used as a pull-down transistor, and the tenth transistor T10 is used as an auxiliary transistor for ripple suppression.

Since the ninth transistor T9 is turned on by the carry signal, its turn-on time is reduced, thereby reducing bias stress. Additionally, since the ninth transistor T9 is turned on by the carry signal from the next signal transfer stage, the falling time of the gate signal is reduced. In addition, the tenth transistor T10, which is turned on during a period when the gate signal is output at a low-level voltage, is designed with a small channel width, so space may be secured.

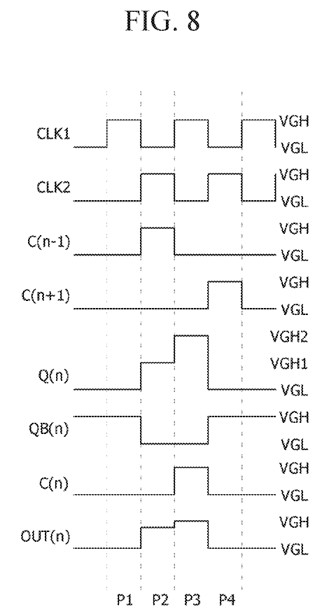

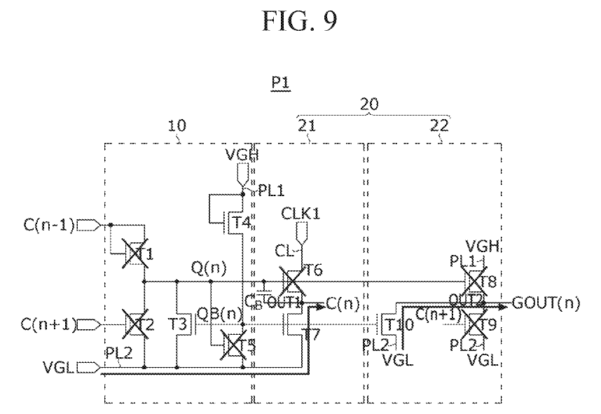

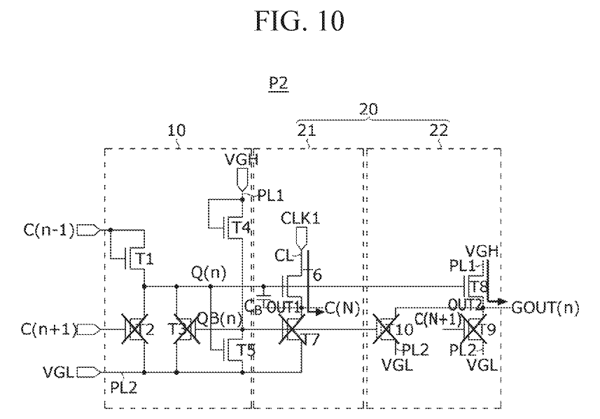

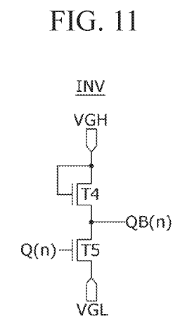

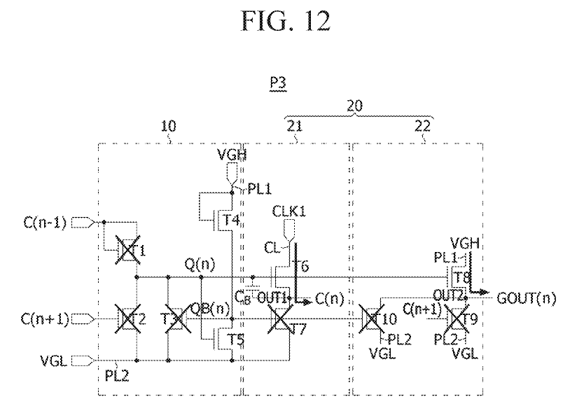

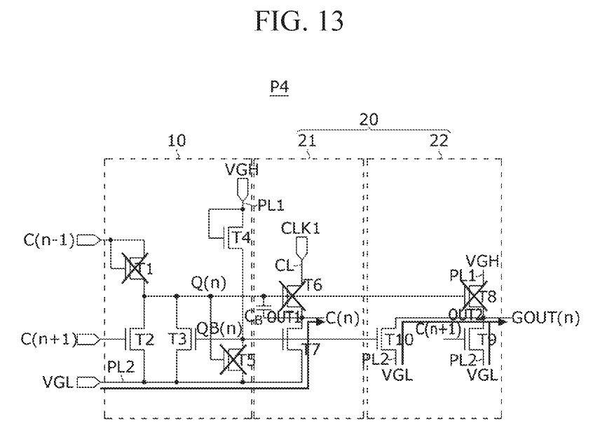

FIG. 8 is a waveform diagram illustrating voltages of the input/output signals and control nodes of the gate driver shown in FIG. 7. FIGS. 9 to 14 are diagrams for explaining the operating principle of the gate driver.

Referring to FIGS. 8 and 9, during the first period (P1), when the carry signal C(n-1) applied from the previous signal transfer stage and the carry signal C(n+1) applied from the next signal transfer stage are a low-level voltage, the first transistor T1, the second transistor T2, and the ninth transistor T9 are turned off.

When the first transistor T1 and the second transistor T2 are turned off, the voltage of the Q node Q(n) is maintained at the low-level voltage, so the fifth transistor T5, the sixth transistor T6, and the eighth transistor T8 are turned off.

The fourth transistor T4 is turned on by the high-potential voltage VGH, and the high-potential voltage VGH is applied to the QB node QB(n) to charge it, and the third transistor T3, the seventh transistor T7 and the tenth transistor T10 are turned on by the voltage charged in the QB node QB(n).

When the seventh transistor T7 is turned on, the low-level voltage is applied to the first output node OUT1, and when the tenth transistor T10 is turned on, the low-level voltage is applied to the second output node OUT2. Hence, the carry signal C(n) becomes a low-level voltage, and the gate signal GOUT(n) becomes a low-level voltage.

During the first period P1, the carry signal C(n) having a low-level voltage is output to the first output node OUT1, and the gate signal GOUT(n) having a low-level voltage is output to the second output node OUT2.

Referring to FIGS. 8 and 10, during the second period P2, when the carry signal C(n-1) applied from the previous signal transfer stage is a high-level voltage, the first transistor T1 is turned on, and when the carry signal C(n+1) applied from the next signal transfer stage is a low-level voltage, the second transistor T2 and the ninth transistor T9 are turned off.

When the first transistor T1 is turned on, the carry signal C(n-1) is applied to the Q node Q(n) to charge it, and the fifth transistor T5, the sixth transistor T6, and the eighth transistor T8 are turned on by the voltage charged in the Q node Q(n).

When the sixth transistor T6 is turned on, the low-level voltage of the clock signal CLK1 is applied to the first output node OUT1, and when the eighth transistor T8 is turned on, the high-potential voltage VGH is applied to the second output node OUT2.

Here, as shown in FIG. 11, the control circuit 10 includes an inverter circuit INV that inverts the voltage of the Q node Q(n) and applies it to the QB node QB(n). The inverter circuit INV includes a fourth transistor T4 and a fifth transistor T5. The inverter circuit INV described here is an example and is not limited thereto. For example, any circuit that inverts the voltage of the Q node Q(n) and applies it to the QB node QB(n) may be applicable as the inverter circuit.

During the second period P2, both the fourth transistor T4 and the fifth transistor T5 are turned on.

In this case, the channel width of the fifth transistor T5 is designed to be larger than that of the fourth transistor T4. The case where the fourth transistor T4 and the fifth transistor T5 are designed to have different channel widths is described here as an example, without being limited thereto. For example, the fourth transistor T4 and the fifth transistor T5 may be designed with different design parameters that may affect the flow of charge, such as at least one of the channel width and the channel length.

Hence, even if a high-potential voltage VGH is applied to the QB node QB(n) through the fourth transistor T4 and a low-potential voltage VGL is applied through the fifth transistor T5, the QB node QB(n) is maintained at a low-level voltage due to the fifth transistor T5 designed to have a large channel width.

While the QB node QB(n) maintains a low-level voltage, the third transistor T3 connected to the QB node QB(n), the seventh transistor T7, and the tenth transistor T10 are turned off.

During the second period P2, the carry signal C(n) having a low-level voltage is output to the first output node OUT1, and the gate signal GOUT(n) having a high-level voltage is output to the second output node OUT2.

Referring to FIGS. 8 and 12, during the third period P3, when the carry signal C(n-1) applied from the previous signal transfer stage and the carry signal C(n+1) applied from the next signal transfer stage are a low-level voltage, the first transistor T1, the second transistor T2, and the ninth transistor T9 are turned off.

The fifth transistor T5, the sixth transistor T6, and the eighth transistor T8 are turned on by the voltage charged in the Q node Q(n).

When the sixth transistor T6 is turned on, the clock signal CLK1 is applied to the first output node OUT1. At this time, the capacitor CB boosts the voltage of the Q node Q(n) due to the high-level voltage of the clock signal CLK1, causing the voltage of the Q node Q(n) to rise.

When the sixth transistor T6 is turned on, the high-level voltage of the clock signal CLK1 is applied to the first output node OUT1 through the sixth transistor T6. When the eighth transistor T8 is turned on, the high-potential voltage VGH is applied to the second output node OUT2 through the eighth transistor T8.

When the fifth transistor T5 is turned on, the QB node QB(n) has a low-level voltage. The third transistor T3, the seventh transistor T7 and the tenth transistor T10 are turned off by the low-level voltage of the QB node QB(n).

During the third period P3, the carry signal C(n) having a high-level voltage is output to the first output node OUT1, and the gate signal GOUT(n) having a high-level voltage is output to the second output node OUT2.

Referring to FIG. 8 and FIG. 13, during the fourth period P4, when the carry signal C(n-1) applied from the previous signal transfer stage is a low-level voltage, the first transistor T1 is turned off, and when the carry signal C(n+1) applied from the next signal transfer stage is a high-level voltage, the second transistor T2 and the ninth transistor T9 are turned on.

When the first transistor T1 is turned off and the second transistor T2 is turned on, the low-potential voltage VGL is applied to the Q node Q(n), and the voltage of the Q node Q(n) is discharged to the low-potential voltage VGL.

When the Q node Q(n) is discharged, the fifth transistor T5, the sixth transistor T6, and the eighth transistor T8 are turned off.

When the high-potential voltage VGH is applied to the QB node QB(n) through the fourth transistor T4 and charges it, the third transistor T3, the seventh transistor T7 and the tenth transistor T10 are turned on by the voltage charged in the QB node QB(n).

Hence, the low-potential voltage VGL is applied to the first output node OUT1, and the low-potential voltage VGL is applied to the second output node OUT2 through the ninth transistor T9 and the tenth transistor T10.

In this case, as shown in FIG. 14, while the low-potential voltage VGL is applied to the second output node OUT2 through the ninth transistor T9 and the tenth transistor T10, as the ninth transistor T9 is turned on by the carry signal C(n+1) transferred from the next signal transfer stage, the falling time of the gate signal GOUT(n) output through the second output node OUT2 may be shortened. For example, the falling time of the gate signal GOUT(n) is shortened from t1~t3 to t1~t2.

Since the ninth transistor T9 is driven by the carry signal C(n+1) applied from the next signal transfer stage, and the tenth transistor T10 is driven by the voltage of the QB node QB(n), the ninth transistor T9 is turned on only for a shorter time than the tenth transistor T10.

The ninth transistor T9 and the tenth transistor T10 used to reduce the falling time of the gate signal may be designed to have a smaller channel width compared to the pull-down transistor shown in FIG. 3.

Even if the ninth transistor T9 is turned off, the tenth transistor T10 may be turned on to maintain the voltage of the gate line to which no gate signal is applied at a low-level voltage.

During the fourth period P4, the carry signal C(n) having a low-level voltage is output to the first output node OUT1, and the gate signal GOUT(n) having a low-level voltage is output to the second output node OUT2.

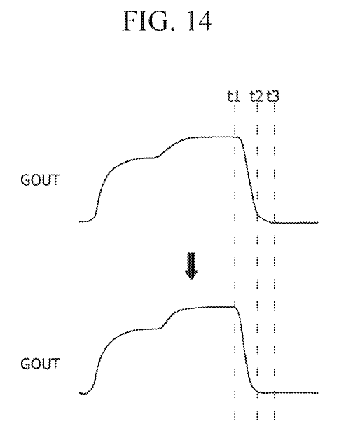

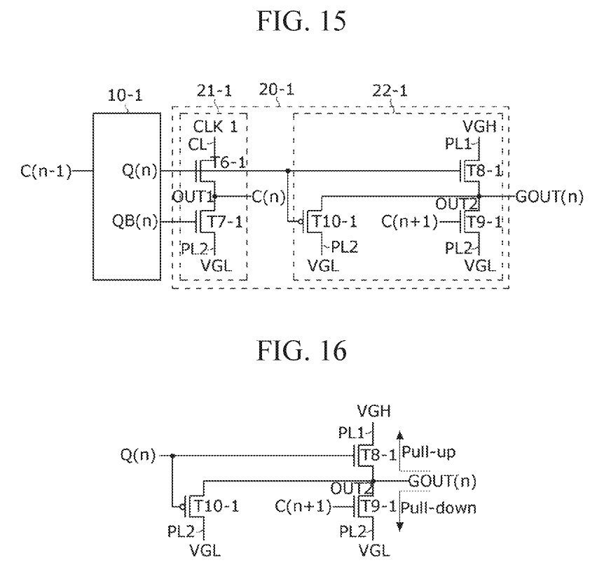

FIGS. 15 and 16 are diagrams illustrating a gate driver according to a second embodiment of the present disclosure.

Referring to FIGS. 15 and 16, each signal transfer stage of the gate driver according to a second embodiment of the present disclosure includes a control circuit 10-1 and an output circuit 20-1. The control circuit 10-1 may charge or discharge the Q node Q(n) and the QB node QB(n).

The control circuit 10-1 may include a charge/discharge circuit that controls charging and discharging of the Q node Q(n) and the QB node QB(n), and an inverter circuit that inverts the voltage of the Q node Q(n) and applies it to the QB node QB(n).

The output circuit 20-1 may output a carry signal C(n) and a gate signal GOUT(n) in correspondence to the potentials of the Q node Q(n) and the QB node QB(n). The output circuit 20 may include a first output circuit 21-1 that outputs a carry signal, and a second output circuit 22-1 that outputs a gate signal.

The first output circuit 21-1 may include first buffer transistors that output a carry signal. The first buffer transistors may include a sixth-1 transistor T6-1, which is a pull-up transistor that is turned on based on the potential of the Q node Q(n), and a seventh-1 transistor T7-1, which is a pull-down transistor that is turned on based on the potential of the QB node QB(n). The sixth-1 transistor T6-1 includes a gate electrode connected to the Q node Q(n), a first electrode connected to the clock signal line CL, and a second electrode connected to the first output node OUT1. The seventh-1 transistor T7-1 includes a gate electrode connected to the QB node QB(n), a first electrode connected to the first output node OUT1, and a second electrode connected to the second power line PL2.

The second output circuit 22-1 may include second buffer transistors that output a gate signal. The second buffer transistors may include an eighth-1 transistor T8-1, which is a pull-up transistor that is turned on based on the potential of the Q node Q(n), a ninth-1 transistor T9-1, which is a pull-down transistor that is turned on based on the potential of the carry signal C(n+1) applied from the next signal transfer stage, and a tenth-1 transistor T10-1 that is turned on based on the potential of the Q node Q(n).

Here, the tenth-1 transistor T10-1 may be implemented with a p-channel TFT because it should be turned on based on the potential of the Q node Q(n) other than the QB node QB(n) as in the first embodiment.

The eighth-1 transistor T8-1 includes a gate electrode connected to the Q node Q(n), a first electrode connected to the first power line PL1, and a second electrode connected to the second output node OUT2. The ninth-1 transistor T9-1 includes a gate electrode connected to the carry signal C(n+1) applied from the next signal transfer stage, a first electrode connected to the second output node OUT2, and a second electrode connected to the second power line PL2. The tenth-1 transistor T10-1 includes a gate electrode connected to the Q node Q(n), a first electrode connected to the second output node OUT2, and a second electrode connected to the second power line PL2.

As shown in FIG. 16, since the ninth-1 transistor T9-1 is turned on by the carry signal C(n+1) from the next signal transfer stage, it may be turned on at the high-level voltage of the carry signal C(n+1).

The tenth-1 transistor T10-1 may be turned on when the voltage of the Q node Q(n) is a low-level voltage, thereby maintaining the voltage of the second output node OUT2 at the low-potential voltage VGL.

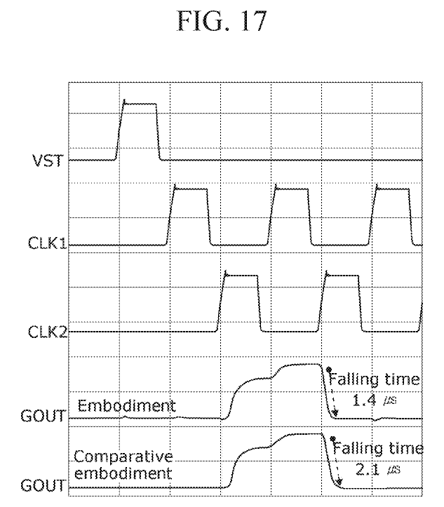

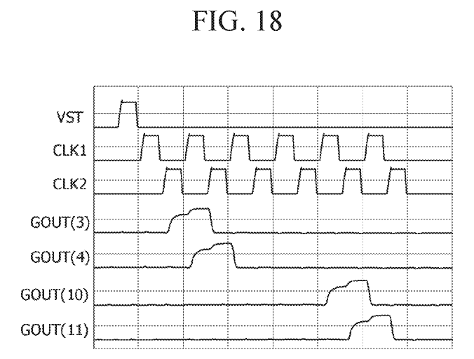

FIGS. 17 and 18 are diagrams illustrating simulation results of the gate driver according to one or more embodiments of the present disclosure.

FIG. 17 shows the simulation results of generating a gate signal by using the gate driver of a comparative embodiment illustrated in FIG. 3 and the gate driver of the embodiment illustrated in FIG. 5.

For example, the falling time of the gate signal generated using the gate driver of the comparative embodiment may be 2.1 μs, and the falling time of the gate signal generated using the gate driver of the embodiment may be 1.4 μs.

Therefore, it may be seen that the falling time of the gate signal generated using the gate driver of the embodiment is reduced by 0.7 μs compared to the falling time of the gate signal according to the comparative embodiment.

Referring to FIG. 18, the gate signal generated using the gate driver according to one or more embodiments of the present disclosure is shown. It can be seen that the falling time of the gate signal applied to each of the plurality of gate lines is shortened, as indicated in FIG. 17, and the signal is output normally.

According to one or more embodiments of the present disclosure, the display device may be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A gate driver, comprising:
a plurality of signal transfer stages that are connected in a cascade via a carry line to which a carry signal is applied from a previous signal transfer stage and output a gate signal according to a clock signal,
wherein an n^{th} signal transfer stage of the plurality of signal transfer stages comprises:
a control circuit configured to:
receive an (n-1)^{th} carry signal from a previous signal transfer stage of the plurality of signal transfer stages, an (n+1)^{th} carry signal from a next signal transfer stage of the plurality of signal transfer stages, and a clock signal, and
charges or discharges a first control node and a second control node; and
an output circuit that outputs a gate signal based on potentials of the first control node and the (n+1)^{th} carry signal,
wherein n is a natural number.

2. The gate driver of claim 1, wherein:
the output circuit includes a first pull-up transistor and a first pull-down transistor;
the first pull-up transistor includes a gate electrode connected to the first control node, a first electrode connected to a first power line to which a high-potential voltage is applied, and a second electrode connected to a first output node from which the gate signal is output; and
the first pull-down transistor includes a gate electrode to which the (n+1)^{th} carry signal is applied, a first electrode connected to the first output node, and a second electrode connected to a second power line to which a low-potential voltage is applied.

3. The gate driver of claim 2, wherein:
the output circuit further includes an auxiliary transistor implemented with an n-channel thin film transistor (TFT); and
the auxiliary transistor includes a gate electrode connected to the second control node, a first electrode connected to the first output node, and a second electrode connected to the second power line.

4. The gate driver of claim 3, wherein a width of a channel of the auxiliary transistor is smaller than a width of a channel of the first pull-down transistor.

5. The gate driver of claim 2, wherein:
the output circuit further includes an auxiliary transistor implemented with a p-channel thin film transistor (TFT); and
the auxiliary transistor includes a gate electrode connected to the first control node, a first electrode connected to the first output node, and a second electrode connected to the second power line.

6. The gate driver of claim 2, wherein:
the output circuit further includes a second pull-up transistor and a second pull-down transistor;
the second pull-up transistor includes a gate electrode connected to the second control node, a first electrode to which the clock signal is applied, and a second electrode connected to a second output node from which a carry signal is output; and
the second pull-down transistor includes a gate electrode connected to the second control node, a first electrode connected to the second output node, and a second electrode connected to the second power line.

7. The gate driver of claim 6, wherein the output circuit further includes a capacitor connected between the gate electrode and the second electrode of the second pull-up transistor.

8. The gate driver of claim 1, wherein:
the control circuit includes a first transistor, a second transistor, a third transistor, a fourth transistor, and a fifth transistor;
the first transistor includes a gate electrode and a first electrode to which an (n-1)^{th} carry signal is applied from the previous signal transfer stage, and a second electrode connected to the first control node;
the second transistor includes a gate electrode to which an (n+1)^{th} carry signal is applied from the next signal transfer stage, a first electrode connected to the first control node, and a second electrode connected to a second power line to which a low-potential voltage is applied;
the third transistor includes a gate electrode connected to the second control node, a first electrode connected to the first control node, and a second electrode connected to the second power line;
the fourth transistor includes a gate electrode and a first electrode connected to a first power line to which a high-potential voltage is applied, and a second electrode connected to the second control node; and
the fifth transistor includes a gate electrode connected to the first control node, a first electrode connected to the second control node, and a second electrode connected to the second power line.

9. The gate driver of claim 8, wherein a width of a channel of the fifth transistor is larger than a width of a channel of the fourth transistor.

10. A display device, comprising:
a display panel on which a plurality of data lines are applied, a plurality of gate lines intersecting the plurality of data lines are applied, a plurality of power lines to which different constant voltages are applied, and a plurality of sub-pixels are arranged;
a data driver configured to supply a data voltage of pixel data to the plurality of data lines; and
a gate driver configured to supply a gate signal to the plurality of gate lines,
wherein the gate driver comprises a plurality of signal transfer stages that are connected in a cascade via a carry line to which a carry signal is applied from a previous signal transfer stage and output a gate signal according to a clock signal, and
wherein an n^{th} signal transfer stage of the plurality of signal transfer stages includes:
a control circuit configured to:
receive an (n-1)^{th} carry signal from a previous signal transfer stage of the plurality of signal transfer stages, an (n+1)^{th} carry signal from a next signal transfer stage of the plurality of signal transfer stages, and a clock signal, and
charges or discharges a first control node and a second control node; and
an output circuit that outputs a gate signal based on potentials of the first control node and the (n+1)^{th} carry signal,
wherein n is a natural number.

11. The display device of claim 10, wherein:
the output circuit includes a first pull-up transistor and a first pull-down transistor;
the first pull-up transistor includes a gate electrode connected to the first control node, a first electrode connected to a first power line to which a high-potential voltage is applied, and a second electrode connected to a first output node from which the gate signal is output; and
the first pull-down transistor includes a gate electrode to which the (n+1)^{th} carry signal is applied, a first electrode connected to the first output node, and a second electrode connected to a second power line to which a low-potential voltage is applied.

12. The display device of claim 11, wherein:
the output circuit further includes an auxiliary transistor implemented with an n-channel thin film transistor (TFT); and
the auxiliary transistor includes a gate electrode connected to the second control node, a first electrode connected to the first output node, and a second electrode connected to the second power line.

13. The display device of claim 12, wherein a width of a channel of the auxiliary transistor is smaller than a width of a channel of the first pull-down transistor.

14. The display device of claim 11, wherein:
the output circuit further includes an auxiliary transistor implemented with a p-channel thin film transistor (TFT); and
the auxiliary transistor includes a gate electrode connected to the first control node, a first electrode connected to the first output node, and a second electrode connected to the second power line.

15. The display device of claim 11, wherein:
the output circuit further includes a second pull-up transistor and a second pull-down transistor;
the second pull-up transistor includes a gate electrode connected to the second control node, a first electrode to which the clock signal is applied, and a second electrode connected to a second output node from which a carry signal is output; and
the second pull-down transistor includes a gate electrode connected to the second control node, a first electrode connected to the second output node, and a second electrode connected to the second power line.

16. The display device of claim 15, wherein the output circuit further includes a capacitor connected between the gate electrode and the second electrode of the second pull-up transistor.

17. The display device of claim 10, wherein:
the control circuit includes a first transistor, a second transistor, a third transistor, a fourth transistor, and a fifth transistor;
the first transistor includes a gate electrode and a first electrode to which an (n-1)^{th} carry signal is applied from the previous signal transfer stage, and a second electrode connected to the first control node;
the second transistor includes a gate electrode to which an (n+1)^{th} carry signal is applied from the next signal transfer stage, a first electrode connected to the first control node, and a second electrode connected to a second power line to which a low-potential voltage is applied;
the third transistor includes a gate electrode connected to the second control node, a first electrode connected to the first control node, and a second electrode connected to the second power line;
the fourth transistor includes a gate electrode and a first electrode connected to a first power line to which a high-potential voltage is applied, and a second electrode connected to the second control node; and
the fifth transistor includes a gate electrode connected to the first control node, a first electrode connected to the second control node, and a second electrode connected to the second power line.

18. The display device of claim 17, wherein a width of a channel of the fifth transistor is larger than a width of a channel of the fourth transistor.
